(19) United States
(12) Patent Application Publication
(10) Pub. No.: US 2026/0122369 A1
(43) Pub. Date: Apr. 30, 2026

(54) IMAGING DEVICE

(71) Applicant: Samsung Electronics Co., Ltd., Suwon-si (KR)

(72) Inventors: Sunyoung YOO, Suwon-si (KR); Seongwook SONG, Suwon-si (KR); Myhyeon KANG, Suwon-si (KR); Dongjin PARK, Suwon-si (KR); Jeehong LEE, Suwon-si (KR); Sunghyuk YIM, Suwon-si (KR)

(73) Assignee: Samsung Electronics Co., Ltd., Suwon-si (KR)

(21) Appl. No.: 19/196,183

(22) Filed: May 1, 2025

(30) Foreign Application Priority Data
Oct. 28, 2024 (KR) 10-2024-0148380

(51) Int. Cl. H04N 25/68; H04N 25/13

(52) U.S. Cl. CPC H04N 25/68; H04N 25/134

(57) ABSTRACT

An imaging device may include an image sensor including a plurality of pixels converting an optical signal into an electrical signal, and an image signal processor (ISP) configured to perform a process for detecting a bad pixel among the plurality of pixels. The image signal processor may list the plurality of pixels based on defect probability of the plurality of pixels respectively being a bad pixel, detect a pixel belonging to a first group in which the defect probability exceeds an outlier reference value among the plurality of pixels, as a first bad pixel, and detect a pixel belonging to a second group, different from the first group, among the plurality of pixels as a second bad pixel using prior information on a probability distribution of the plurality of pixels becoming bad pixels after a certain period of time.

### CROSS-REFERENCE TO RELATED APPLICATIONS

This application claims the benefit under 35 USC 119(a) of Korean Patent Application No. 10-2024-0148380 filed on Oct. 28, 2024 in the Korean Intellectual Property Office, the entire disclosure of which is incorporated herein by reference for all purposes.

### BACKGROUND

The present inventive concepts relate to an imaging device.

An imaging device is a device that receives light and generates image data, and may include an image sensor including a plurality of pixels generating electric signals in response to light, and a signal processor generating the image data.

### SUMMARY

Example embodiments provide an imaging device capable of detecting bad pixels using prior information.

According to example embodiments, an imaging device may include an image sensor including a plurality of pixels converting an optical signal into an electrical signal; and an image signal processor (ISP) performing a process for detecting a bad pixel among the plurality of pixels. The image signal processor may list the plurality of pixels based on defect probability, in which the plurality of pixels are respectively a bad pixel, detect a pixel belonging to a first group in which the defect probability exceeds an outlier reference value among the plurality of pixels, as a first bad pixel, and detect a pixel belonging to a second group, different from the first group, among the plurality of pixels as a second bad pixel using prior information on a probability distribution of the plurality of pixels becoming bad pixels after a certain period of time.

According to example embodiments, an imaging device may include an image sensor including a plurality of pixels converting an optical signal into an electrical signal; and an image signal processor (ISP) performing a process for detecting a bad pixel among the plurality of pixels. The image signal processor may list the plurality of pixels based on a code level, which is a digital value of a digital signal output by each pixel, detect a pixel belonging to a first group in which the code level exceeds an outlier reference value among the plurality of pixels, as a first bad pixel, and detect a pixel belonging to a second group, different from the first group, among the plurality of pixels as a second bad pixel by using prior information about a code level at which a probability of occurrence of the bad pixel is high over a certain period of time.

According to example embodiments, an imaging device may include an image sensor including a plurality of pixels converting an optical signal into an electrical signal; and an image signal processor (ISP) performing a process for detecting a bad pixel among the plurality of pixels. The image signal processor may detect a bad pixel among the plurality of pixels by using prior information about a probability distribution of the plurality of pixels respectively becoming a bad pixel after a certain period of time, and correct a pixel value of a noise pixel corresponding to the bad pixel by replacing the pixel value with an average of pixel values of four other image pixels adjacent to the noise pixel (e.g., on top, bottom, left and right).

### BRIEF DESCRIPTION OF DRAWINGS

The above and other aspects, features, and advantages of the present inventive concepts will be more clearly understood from the following detailed description, taken in conjunction with the accompanying drawings, in which:

FIG. 1 is a drawing illustrating an external environment of an imaging device according to example embodiments;

FIG. 2 is a block diagram simply illustrating an imaging device according to example embodiments;

FIG. 3 and FIG. 4 are graphs illustrating a distribution of a plurality of pixels according to example embodiments;

FIG. 5 is a flowchart illustrating the order in which an image signal processor, according to example embodiments, operates;

FIG. 6A to 6G and FIG. 7 are drawings simply illustrating a sub-pixel group according to example embodiments;

FIG. 8 to FIG. 10 are graphs illustrating a distribution of a plurality of pixels according to example embodiments; and

FIGS. 11A and 11B are graphs illustrating a distribution of a plurality of pixels according to example embodiments.

### DETAILED DESCRIPTION

Hereinafter, example embodiments will be described with reference to the accompanying drawings.

As described herein, an imaging device is a device that receives light and generates image data, and may include an image sensor including a plurality of pixels generating electric signals in response to light, and a signal processor generating the image data.

Bad pixels may occur among the plurality of pixels during the manufacturing process of the imaging device and/or during the aging process after the imaging device is shipped, and bad pixels may also occur due to an external environment exposed to radiation such as cosmic rays and alpha radiation. In this way, various studies are being conducted to detect bad pixels caused by various causes and to improve the performance of the imaging device.

According to some embodiments, an imaging device is provided that is capable of detecting defective pixels based at least in part on prior information. The imaging device may include a processor configured to perform pixel detection such that a separate memory storing defect information is not required. The imaging device according to the present embodiments may incorporate prior information on the probability, possibility, and/or distribution of a normal pixel becoming a defective pixel over time, and thus, may detect defective pixels caused by radiation or other causes described herein. Therefore, as described further herein, the image signal processor may detect defective pixels using the prior information, and correct noise pixels corresponding to the defective pixels, thereby reducing the influence of the defective pixels on image data, and improving the performance of the imaging device.

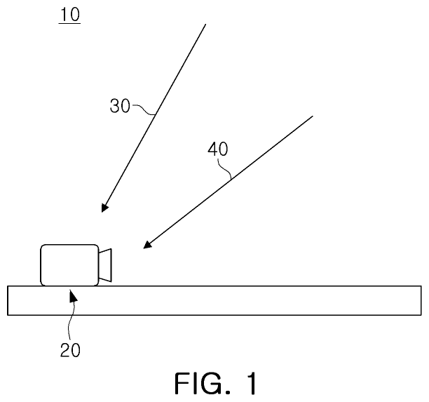

FIG. 1 is a drawing illustrating the external environment of an imaging device according to example embodiments.

Referring to FIG. 1, an imaging device 20 according to example embodiments may be exposed to various external environments 10. The imaging device 20 according to example embodiments described with reference to FIG. 1 may be exposed to an external environment 10 in which cosmic rays 30 and alpha radiation 40 are relatively strong.

Radiation generates high-energy particles such as thermal neutrons and fast neutrons, and when high-energy particles collide with the imaging device 20, various problems may occur. For example, the imaging device 20 may include at least one semiconductor element such as a transistor. When the high-energy particles as described above collide with a semiconductor element included in the imaging device 20, a bad pixel may be generated and noise may be generated in the image data. A bad pixel may detect the intensity of external light as being too bright or too dark compared to surrounding pixels, and the bad pixel may cause the performance of the imaging device 20 to deteriorate or, in severe cases, cause permanent damage.

In example embodiments, to resolve the above problem, the performance of the imaging device may be improved by detecting a bad pixel caused by a cause such as radiation and correcting the pixel value generated by the bad pixel. An imaging device according to example embodiments may include an image signal processor (ISP) configured to perform a process of detecting a noise pixel appearing in image data due to a bad pixel (e.g., by executing an algorithm in the ISP). The image signal processor may detect a bad pixel using prior information including information about the probability of a bad pixel occurring due to a cause such as radiation. In example embodiments, the image signal processor may correct the pixel value of the noise pixel corresponding to the detected bad pixel, thereby reducing the influence of the bad pixel on the image data and providing an imaging device with improved performance.

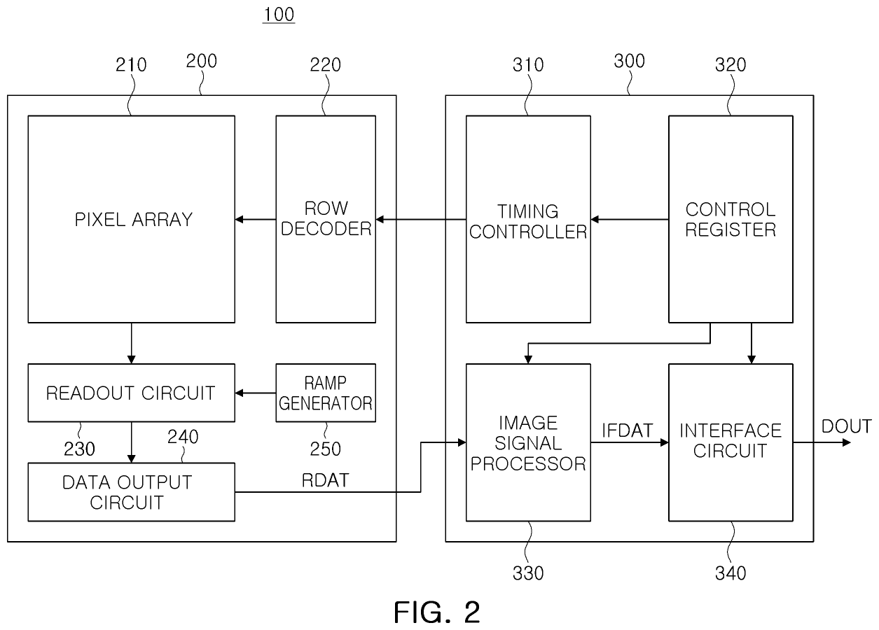

FIG. 2 is a block diagram simply illustrating an imaging device according to example embodiments.

Referring to FIG. 2, the imaging device 100 may include an image sensor 200 and a processor 300. The image sensor 200 includes a pixel array 210 and peripheral circuits 220 to 250, and the pixel array 210 may include a plurality of pixels disposed in an array form along a plurality of rows and a plurality of columns. A photoelectric conversion element generating a charge in response to light is disposed in each of the plurality of pixels, and the photoelectric conversion element may be connected to a pixel circuit generating and outputs an electric signal corresponding to the charge generated by the photoelectric conversion element.

The photoelectric conversion element may include a photodiode formed of a semiconductor material, and/or an organic photodiode formed of an organic material. For example, the pixel circuit may include a plurality of transistors and a capacitor. The capacitor may store an excessive charge generated by the photodiode, and may be connected to the photodiode through at least one transistor. In example embodiments, the capacitor may be a Metal-Insulator-Metal (MIM) capacitor.

The peripheral circuits 220 to 250 may include circuits for controlling the pixel array 210. For example, the peripheral circuits 220 to 250 may include a row decoder 220, a readout circuit 230, a data output circuit 240, a ramp generator 250, and the like. The peripheral circuits 220 to 250 may operate in response to a command, for example, a timing signal, transmitted by a timing controller 310 of the processor 300. The row decoder 220 may drive the pixel array 210 in units of row lines.

Among the pixels, pixels disposed in the same position along the row direction (horizontal direction in FIG. 2) may share the same column line. For example, pixels disposed in the same position in the column direction (vertical direction of FIG. 1) may be simultaneously selected by the row decoder 220 and output voltage signals through the column lines.

The readout circuit 230 may include a plurality of correlated dual samplers and a plurality of counters, and the correlated dual samplers may be connected to the pixels and the column lines. For example, one correlated dual sampler and one counter may be connected to one column line. The correlated dual samplers may read voltages from the pixels connected to the row line selected by the row decoder 220 through the column lines. One input terminal among input terminals of the respective correlated dual samplers may be connected to the column lines, and the other input terminal may receive a ramp voltage from the ramp generator 250.

Respective output terminals of the correlated dual samplers are connected to the counters, and the counters may generate a digital pixel signal by counting the time during which respective outputs of the correlated dual samplers are maintained at a specific voltage. For example, the counter may count the time during which the ramp voltage input to the correlated double sampler is greater than the voltage of the column line, and convert the output of the correlated double sampler into a digital pixel signal. The data output circuit 240 may include a memory such as a latch or a buffer circuit that temporarily stores the digital pixel signal, and may output raw data RDAT including the digital pixel signal to the image signal processor 330.

The operation of the image sensor 200 may be controlled by the timing controller 310 of the processor 300. The timing controller 310 may control the operation timing of the image sensor 200 in response to a command received from the control register 320. Meanwhile, the image signal processor 330 may receive raw data RDAT from the data output circuit 240 and generate image data IFDAT using the raw data RDAT. The interface circuit 340 may transmit output data DOUT including the image data IFDAT to the outside using a predefined protocol, for example, a Mobile Industry Processor Interface (MIPI) interface.

In example embodiments, a plurality of pixels included in the pixel array 210 may include bad pixels that do not operate normally. Bad pixels are mainly generated during the manufacturing process of the imaging device 100, but may also be generated after the imaging device 100 is shipped due to aging of the image sensor 200 or external environments such as exposure to cosmic rays and alpha radiation.

Bad pixels may be classified into static bad pixels and dynamic bad pixels. Static bad pixels may refer to bad pixels that are always in a fixed position in the image sensor 200, and may refer to pixels that do not change depending on conditions and always cause defects in the same state. Dynamic bad pixels may refer to bad pixels that appear only under certain conditions or environments in the image sensor 200. Dynamic bad pixels may change depending on various conditions such as lighting, temperature, and shutter speed, or may operate as bad pixels only in certain situations. For example, dynamic bad pixels may occur in a high-temperature environment, and dynamic bad pixels may appear when shooting with a long exposure time by setting the shutter speed long. In example embodiments, a bad pixel may mainly refer to a dynamic bad pixel.

A dynamic bad pixel may include a hot pixel and a cold pixel. A hot pixel is a pixel that detects light intensity stronger than it actually is, and a noise pixel caused by a hot pixel may appear very bright or white in the image data. A cold pixel is a pixel that does not detect light properly or detects light intensity weaker than it actually is, and a noise pixel caused by a cold pixel may appear black or very dark in the image data.

In example embodiments, a dark image test may be performed to detect a bad pixel among a plurality of pixels. The dark image test may be a test generating image data while covering a lens (not illustrated) included in an imaging device 100 to block light, and checks whether there is a bad pixel among a plurality of pixels that does not detect light or outputs an incorrect value through the generated image data. If the plurality of pixels respectively operate normally, black image data should be output, but noise pixel with a bright dot or a specific color may appear in the image data due to a bad pixel.

In example embodiments, the image signal processor 330 may perform a process for detecting a bad pixel and prior information on a probability distribution. The process for detecting a bad pixel may include detecting a bad pixel among a plurality of pixels and correcting the pixel value of a noise pixel corresponding to the bad pixel. The process for detecting a bad pixel may be performed using an artificial intelligence algorithm (e.g., built into the ISP) that uses prior information on the probability distribution and may be performed according to at least one of a machine learning, neural network, or deep learning algorithm. The prior information may include information on a probability distribution of a plurality of pixels becoming bad pixels after a certain period of time, or information on a code level of an image pixel with a high probability of occurrence of a bad pixel after a certain period of time.

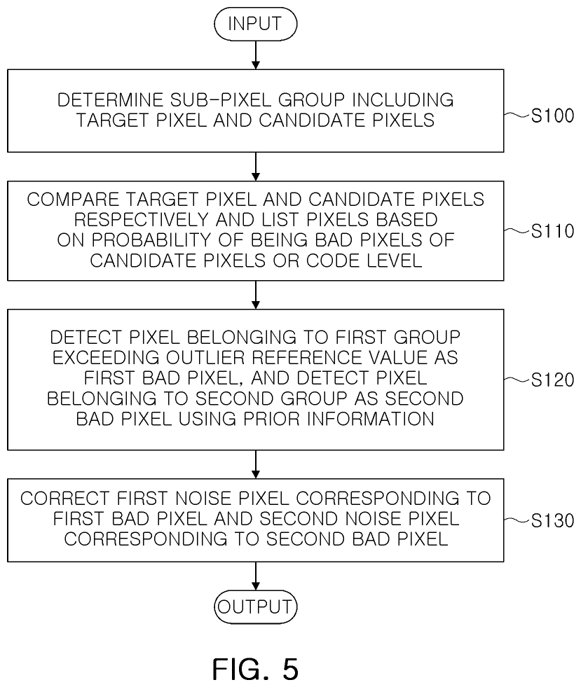

The image signal processor may be configured to determine a defect probability of at least some of the plurality of pixels being a bad pixel or a code level of at least some of the plurality of pixels. The image signal processor may list a plurality of pixels based on a probability of each of the plurality of pixels becoming a bad pixel or a code level of the image pixel. Thereafter, the image signal processor detects a pixel belonging to a first group whose defect probability exceeds an outlier reference value or whose code level exceeds an outlier reference value among the listed plurality of pixels as a first bad pixel, and may detect a pixel belonging to a second group, different from the first group, among the plurality of pixels as a second bad pixel using prior information. The image signal processor detecting the bad pixel will be described in detail in relation to FIG. 5 below.

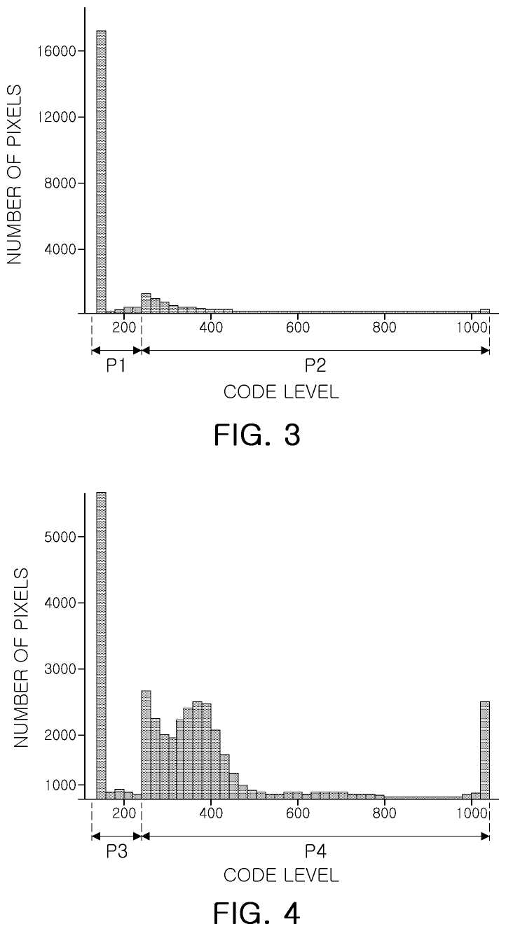

FIG. 3 and FIG. 4 are graphs illustrating the distribution of a plurality of pixels according to example embodiments.

In example embodiments, an imaging device may include an image sensor and an image signal processor. The image sensor may include a plurality of pixels that convert an optical signal into an electrical signal. The image signal processor may perform a process for detecting a bad pixel among the plurality of pixels. In example embodiments, the image signal processor may detect a pixel belonging to the first group as a first bad pixel, and may detect a pixel belonging to a second group, different from the first group, as a second bad pixel using prior information.

FIGS. 3 and 4 illustrate graphs consisting of an X-axis representing the code levels of a plurality of respective pixels and a Y-axis representing the number of pixels. The code level may refer to a digital value or data level of a digital signal output by each pixel in an image sensor. In detail, the signal of each pixel may be expressed as a digital value of a specific number of bits. An image sensor according to example embodiments may generate 10-bit image data, and the code levels of respective image pixels included in the image data may have a value between 0 and 1023. In the image data generated by the imaging device, a dark area may refer to a low code level, and a bright area may refer to a high code level.

FIG. 3 may be a histogram distribution illustrating the result of a dark image test performed immediately after the imaging device according to example embodiments is shipped. Since the dark image test is performed while blocking light, the code level of a normal image pixel may have a value close to 0. In example embodiments, for 10-bit image data, if a code level of an image pixel has a value between about 0 and 200, the corresponding pixels may be considered to be operating normally. If the code level value of an image pixel is in the P1 section, the corresponding pixels may be considered to be operating normally, and if the code level of an image pixel is in the P2 section, the corresponding pixels may be considered to be bad pixels that do not operate normally. In particular, a pixel corresponding to an image pixel having a high code level value despite blocking light may be a hot pixel. However, the code level range of an image pixel corresponding to a pixel that may be considered to be operating normally is not limited to 0 to 200, and may be larger or smaller than this.

FIG. 4 may be a histogram distribution illustrating the results of a dark image test performed after the imaging device according to example embodiments is left in an external environment for a certain period of time, after being shipped. In example embodiments, referring to FIG. 4, if the code level of an image pixel is in the P3 section, the corresponding pixels may be viewed as pixels that operate normally, and if the code level of an image pixel is in the P4 section, the corresponding pixels may be viewed as bad pixels that do not operate normally. In example embodiments, the dark image test may be performed after the imaging device is left in an external environment affected by radiation or the like for two months after being shipped.

In example embodiments, some pixels that were operating normally immediately after the imaging device was shipped may become bad pixels after a certain period of time due to defects caused by radiation, or the like. Some bad pixels that were not operating normally immediately after the imaging device was shipped may naturally have their defects healed after a certain period of time and become pixels that operate normally. Referring to FIGS. 3 and 4 together, some normal pixels whose code levels of image pixels were in the P1 section may become bad pixels whose code levels of image pixels were in the P4 section over time, and some bad pixels whose code levels of image pixels were in the P2 section may become normal pixels whose code levels of image pixels were in the P3 section over time.

In example embodiments, an image signal processor may detect bad pixels among a plurality of pixels using prior information, for example using an algorithm embedded in the ISP. The prior information may include information about a probability distribution of each of the plurality of pixels becoming bad pixels over time by comparing a plurality of pixels immediately after the imaging device is shipped with a plurality of pixels after being exposed to an external environment for a certain period of time. In example embodiments, the prior information may include information about a code level of an image pixel having a high probability of occurrence of a bad pixel over a certain period of time.

An image signal processor may detect a pixel belonging to a first group in which respective code levels of a plurality of image pixels corresponding to a plurality of pixels exceed an outlier reference value, as a first bad pixel, and may detect a pixel belonging to a second group as a second bad pixel by using prior information about the code levels of image pixels having a high probability of occurrence of bad pixels over a certain period of time. An image signal processor according to example embodiments may detect a bad pixel caused by radiation or the like, and reduce the influence of the bad pixel on image data and improve the performance of an imaging device by correcting the pixel value of a noise pixel corresponding to the detected bad pixel.

FIG. 5 is a flowchart illustrating the operation sequence of an image signal processor according to example embodiments.

An imaging device according to example embodiments may include an image sensor and a processor. The image sensor may include a plurality of pixels that convert an optical signal into an electrical signal, and the processor may include an image signal processor configured to detect a bad pixel among the plurality of pixels, for example by executing a built-in algorithm. In example embodiments, the image signal processor may detect a bad pixel and correct the pixel value of a noise pixel corresponding to the bad pixel.

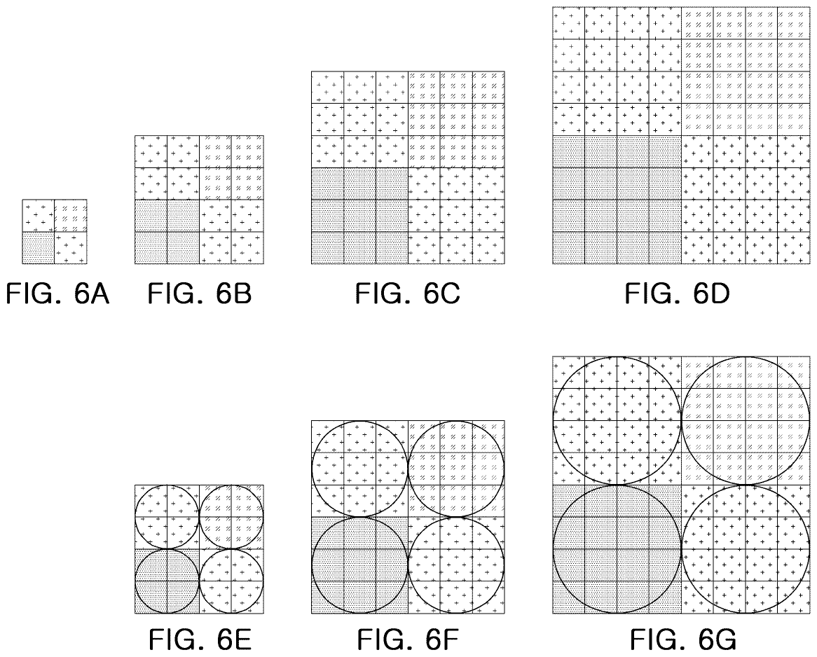

An image signal processor according to example embodiments may determine a sub-pixel group including a target pixel and candidate pixels (act S100). The image signal processor may determine a sub-pixel group having an n×n size, and may determine the target pixel and candidate pixels among the pixels included in the sub-pixel group. For example, the sub-pixel group may have a 3×3 size, the target pixel may be a pixel positioned at the center of the sub-pixel group, and the candidate pixels may be eight pixels positioned around the target pixel. However, the size of the sub-pixel group is not limited thereto, and may be larger or smaller than the 3×3 size. The target pixel is not limited to a pixel positioned in the center of the sub-pixel group. In example embodiments, pixels included in the sub-pixel group may have the same color filter or may have different color filters. This will be described in detail in relation to FIGS. 6A to 6G below.

An image signal processor according to example embodiments may compare a target pixel and candidate pixels, respectively, and list the candidate pixels based on the probability of being a bad pixel or the code level of the image pixel (act S110). The image signal processor may determine one target pixel from the sub-pixel group, and determine the remaining pixels excluding the target pixel from among the pixels included in the sub-pixel group as candidate pixels. The image signal processor may compare the target pixel and candidate pixels, respectively, and list the pixels based on the probability of being a bad pixel compared to the target pixel. Alternatively, the image signal processor may compare the target pixel and candidate pixels, respectively, and list the candidate pixels based on the difference between the probability of being a bad pixel of the target pixel and the probability of being a bad pixel of the candidate pixel. In example embodiments, the image signal processor may compare the target pixel and the candidate pixels, and list the same, based on the difference in the code level of the image pixels corresponding to the candidate pixels or the code level of the image pixels corresponding to the target pixel and the candidate pixels.

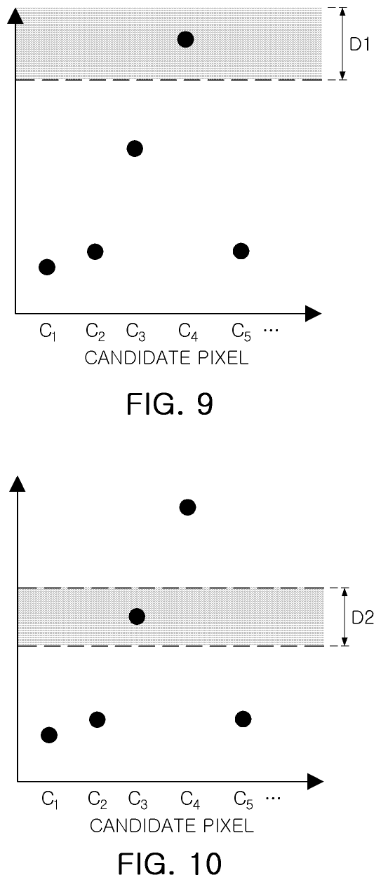

According to example embodiments, the image signal processor may detect a pixel belonging to a first group exceeding an outlier reference value as a first bad pixel, and may detect a pixel belonging to a second group as a second bad pixel using prior information (act S120). In example embodiments, the outlier reference value may refer to a criterion for identifying a first group to which a pixel having defect probability significantly different from the defect probability of other candidate pixels belongs. Alternatively, in example embodiments, the outlier reference value may refer to a criterion for identifying a first group to which a pixel corresponding to an image pixel having a code level significantly different from the code levels of image pixels corresponding to other candidate pixels belongs. The image signal processor may detect a pixel belonging to the first group as a first bad pixel. This will be described in detail in relation to FIG. 9 below.

An image signal processor may detect pixels belonging to a second group, which are different from a first group, among a plurality of pixels, as second bad pixels using prior information. The second group may be different from the first group, which exceeds an outlier reference value. Information about the second group may be obtained using prior information. For example, the prior information may include information about a code level of an image pixel having a high probability of becoming a bad pixel over a certain period of time. The second group may include pixels corresponding to a code level of an image pixel having a high probability of becoming a bad pixel over time. The image signal processor may detect pixels belonging to the second group as second bad pixels. This will be described in detail with reference to FIG. 10 below. In example embodiments, the prior information may include information about a probability distribution of each of the plurality of pixels becoming a bad pixel when a certain period of time has passed.

An image signal processor according to example embodiments may compensate a first noise pixel corresponding to a first bad pixel and a second noise pixel corresponding to a second bad pixel (act S130). In example embodiments, the image signal processor may detect a bad pixel among a plurality of pixels and compensate a pixel value of a noise pixel corresponding to the bad pixel. In example embodiments, the image signal processor may compensate by replacing the pixel value of the first noise pixel corresponding to the first bad pixel with an average of pixel values of four other image pixels adjacent to the top, bottom, left, and right of the first noise pixel. In example embodiments, the image signal processor may compensate by replacing the pixel value of the first noise pixel corresponding to the first bad pixel with an average of pixel values of eight other image pixels adjacent to the top, bottom, left, and right of the first noise pixel and diagonally.

The image signal processor may also compensate the second noise pixel corresponding to the second bad pixel in the same manner as the first noise pixel. An image signal processor according to example embodiments may significantly reduce the influence of a bad pixel on image data by using various algorithms to correct a noise pixel corresponding to a bad pixel or by processing the noise pixel so that it is not visible in the image data. In example embodiments, a bad pixel may be detected using prior information, and by correcting a noise pixel corresponding to a bad pixel, the influence of a bad pixel on image data may be reduced and the performance of an imaging device may be improved.

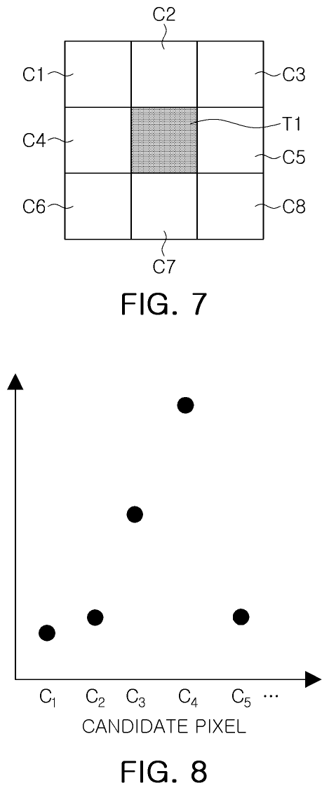

FIGS. 6 and 7 are drawings simply illustrating a sub-pixel group according to example embodiments.

An imaging device according to example embodiments may include an image sensor and an image signal processor. The image sensor may include a pixel array including a plurality of pixels capable of converting an optical signal into an electrical signal. The image signal processor may perform a process for detecting a bad pixel among the plurality of pixels.

Each of the plurality of pixels may include a color filter. The color filter may include a first color filter that selectively transmits light of a first wavelength, a second color filter that selectively transmits light of a second wavelength, and a third color filter that selectively transmits light of a third wavelength. In example embodiments, the first color filter may be a red filter, the second color filter may be a blue filter, and the third color filter may be a green filter.

Referring to FIGS. 6A to 6G, the pixel array included in the image sensor according to example embodiments may be arranged in various patterns. In example embodiments, the pixel array may be arranged in a Bayer pattern. Referring to a pattern of FIG. 6A, the pixel array may be arranged in a Bayer pattern consisting of one pixel having a first color filter, one pixel having a second color filter, and two pixels having a third color filter. The pixel having the red filter may be disposed between the pixels having the green filter in a grid shape, and the pixel having the blue filter may also be disposed between the pixels having the green filter in a grid shape.

However, the number of pixels having the first color filter, the second color filter, and the third color filter in the Bayer pattern is not limited thereto. The Bayer pattern may be composed of one first pixel group consisting of pixels having a first color filter, one second pixel group consisting of pixels having a second color filter, and two third pixel groups consisting of pixels having a third color filter. Referring to a pattern of FIG. 6B, in example embodiments, the first pixel group, the second pixel group, and the third pixel groups disposed in the pixel array may each include four pixels arranged in a 2×2 array. Referring to a pattern of FIG. 6C, the first to third pixel groups disposed in the pixel array may each include nine pixels arranged in a 3×3 array, and referring to a pattern of FIG. 6D, the first to third pixel groups may each include 16 pixels arranged in a 4×4 array.

In example embodiments, the first pixel group, the second pixel group, and the third pixel groups included in the pixel array may respectively share one micro lens. Referring to a pattern of FIG. 6E, the first pixel group, the second pixel group, and the third pixel groups may each include four pixels arranged in 2×2, and the four pixels may share one micro lens. Referring to a pattern of FIG. 6F, the first to third pixel groups may each include nine pixels arranged in 3×3, and the nine pixels may share one micro lens. Referring to a pattern of FIG. 6G, the first to third pixel groups may each include 16 pixels arranged in 4×4, and the 16 pixels may share one micro lens. However, the present inventive concepts are not limited thereto, and only pixels included in at least one pixel group among the first to third pixel groups included in the Bayer pattern may share one micro lens, and pixels included in other pixel groups may each include one micro lens.

In example embodiments, the image signal processor may detect a bad pixel for a pixel array having at least one pattern among the patterns of FIGS. 6A to 6G. The image signal processor may determine a sub-pixel group with at least one pattern among the patterns of FIGS. 6A to 6G. However, the present inventive concepts are not limited to the patterns of FIGS. 6A to 6G, and the image signal processor may also detect a bad pixel for a pixel array having other patterns.

In example embodiments, the image signal processor may determine a sub-pixel group including pixels having one color filter. In this case, the target pixel and candidate pixels included in the sub-pixel group may include the same color filter. Alternatively, in example embodiments, the image signal processor may determine a sub-pixel group including pixels having at least one color filter among the first to third color filters. The target pixel and candidate pixels included in the sub-pixel group may have the same color filter or may have different color filters. In example embodiments, pixels included in a sub-pixel group may include only one color filter among the first to third color filters, or may include only two color filters among the first to third color filters, or may include all of the first to third color filters.

The process of detecting a bad pixel performed in an image signal processor according to example embodiments may be applied to pixel arrays of various patterns. The image signal processor may detect a bad pixel for pixels having the same color filter, or may detect a bad pixel for pixels having different color filters. There is no limitation on the pattern of the pixel array in which the image signal processor may detect a bad pixel, and there is no limitation on the color filter in which the image signal processor may detect a bad pixel. Since the image signal processor may detect a bad pixel for all or some of the pixels having a specific color filter, a bad pixel may be efficiently detected, and according to example embodiments, the pixel value of a noise pixel corresponding to a bad pixel may be corrected, so that an imaging device with improved performance may be provided.

FIG. 7 is a diagram simply illustrating a sub-pixel group according to example embodiments. An imaging device according to example embodiments may include an image sensor and a processor. The processor may include an image signal processor configured to detect a bad pixel among a plurality of pixels, for example by executing a built-in algorithm. The image signal processor may detect a bad pixel by determining a sub-pixel group. Referring to FIG. 7, the image signal processor may determine a sub-pixel group of 3×3 size. However, the size of the sub-pixel group is not limited thereto, and may be larger or smaller than the 3×3 size.

In example embodiments, the sub-pixel group may include a target pixel T1 and first to eighth candidate pixels C1 to C8. The target pixel T1 may be a pixel positioned at the center of the sub-pixel group, and the candidate pixels C1 to C8 may be pixels other than the target pixel. The image signal processor may compare the target pixel T1 with the candidate pixels C1 to C8, respectively.

The image signal processor may compare the defect probability of the target pixel T1 with the defect probability of the candidate pixels C1 to C8, respectively. The image signal processor may list the candidate pixels C1 to C8 based on the failure probability of the target pixel compared to the candidate pixels, or may list pixels based on the difference between the failure probability of the target pixel T1 and the failure probability of the candidate pixels C1 to C8. Among the candidate pixels C1 to C8, pixels that have a relatively high failure probability compared to other candidate pixels C1 to C8 or a relatively large difference in failure probability from the target pixel T1 may be determined by the image signal processor to belong to the first group that exceeds the outlier reference value.

Alternatively, in example embodiments, the image signal processor may compare the code level of the image pixel corresponding to the target pixel T1 with the code level of the image pixels corresponding to the candidate pixels C1 to C8. The image signal processor may list pixels based on the code level of the image pixel corresponding to the candidate pixels C1 to C8, or may list pixels based on the difference between the code level of the image pixel corresponding to the target pixel T1 and the code level of the image pixels corresponding to the candidate pixels C1 to C8. The image signal processor may determine that a pixel whose code level of a corresponding image pixel is relatively high or whose difference from the code level of the image pixel corresponding to the target pixel T1 is relatively large belongs to the first group that exceeds the outlier reference value.

In example embodiments, the image signal processor may change the target pixel within the same sub-pixel group. For example, the target pixel may be changed to the first candidate pixel C1, and may be compared with the first candidate pixel C1 and the second to eighth candidate pixels C2 to C8, and the previous target pixel T1, respectively, to be listed.

In example embodiments, the image signal processor may also change the sub-pixel group itself. In this case, some pixels may overlap between the pixels included in the sub-pixel group before the change and the pixels included in the sub-pixel group after the change. For example, the image signal processor may detect a bad pixel by determining a sub-pixel group including pixels corresponding to image pixels of a code level with a high probability of occurrence of a bad pixel. Alternatively, the image signal processor may detect a bad pixel by checking whether all of a plurality of pixels are bad pixels while changing the sub-pixel group.

An image signal processor included in an image signal processor according to example embodiments may determine a sub-pixel group, determine a target pixel and candidate pixels among pixels included in the sub-pixel group, and detect a bad pixel. The image signal processor may compare the defect probability of candidate pixels or the code levels of image pixels corresponding to candidate pixels while changing the target pixel within the same sub-pixel group. In this manner, the image signal processor may efficiently detect bad pixels and provide an imaging device with improved quality.

FIGS. 8 to 10 are graphs illustrating the distribution of a plurality of pixels according to example embodiments.

An imaging device according to example embodiments may include an image sensor and a processor. The processor may include an image signal processor having a built-in algorithm for detecting bad pixels among a plurality of pixels.

FIGS. 8 to 10 are graphs formed by an X-axis representing candidate pixels and a Y-axis representing the defect probability of candidate pixels or the code levels of image pixels corresponding to candidate pixels. In example embodiments, FIG. 8 may be a graph illustrating the difference in the code levels of image pixels corresponding to the target pixel and the candidate pixels C1 to Ci by comparing the code levels of image pixels corresponding to the target pixel and the code levels of image pixels corresponding to the candidate pixels C1 to Ci. Referring to FIG. 8, the image pixel corresponding to the first candidate pixel C1 may have the smallest difference in code level from the image pixel corresponding to the target pixel, and the image pixel corresponding to the fourth candidate pixel C4 may have the largest difference in code level from the image pixel corresponding to the target pixel. The image pixel corresponding to the second candidate pixel C2 may have a relatively small difference in code level from the image pixel corresponding to the target pixel, and the image pixel corresponding to the third candidate pixel C3 may have a relatively large difference in code level from the image pixel corresponding to the target pixel. In example embodiments, FIG. 8 may be a graph illustrating the code levels of the image pixels corresponding to the respective candidate pixels C1 to Ci.

In example embodiments, FIG. 8 may be a graph illustrating the difference in the probability of failure of the target pixel and the candidate pixels C1 to Ci by comparing the target pixel and the candidate pixels C1 to Ci. Referring to FIG. 8, the first candidate pixel C1 may have the smallest difference in defect probability with respect to the target pixel, and the fourth candidate pixel C4 may have the largest difference in defect probability with respect to the target pixel. The second candidate pixel C2 may have a relatively small difference in defect probability with respect to the target pixel, and the third candidate pixel C3 may have a relatively large difference in defect probability with respect to the target pixel. In example embodiments, FIG. 8 may also be a graph illustrating the defect probability of each of the candidate pixels C1 to Ci.

Referring to FIG. 9, the image signal processor may detect a pixel belonging to a first group D1 among a plurality of pixels whose defect probability exceeds an outlier reference value as a first bad pixel. The first group D1 may include a pixel having the highest defect probability compared to other candidate pixels. Alternatively, in example embodiments, the first group D1 may include a pixel having the highest difference in defect probability from a target pixel compared to other candidate pixels. Referring to FIG. 9, the image signal processor may detect a first bad pixel in the first group D1 including a fourth candidate pixel C4 having the highest defect probability. The outlier reference value may be determined in advance as a specific defect probability, or the image signal processor may set the pixel having the highest defect probability as a criterion.

In example embodiments, the image signal processor may detect a pixel belonging to a first group D1 among a plurality of image pixels corresponding to a plurality of pixels whose code level exceeds an outlier reference value as a first bad pixel. The first group D1 may include pixels corresponding to image pixels having a significantly higher code level than other candidate pixels. Alternatively, in example embodiments, the first group D1 may include pixels corresponding to image pixels having the largest difference in code level between the target pixel and the other candidate pixels. Referring to FIG. 9, the image signal processor may detect a first bad pixel in the first group D1 including a fourth candidate pixel C4 corresponding to the image pixel having the highest code level. The outlier reference value may be determined in advance as a specific code level value, or the image signal processor may set the pixel corresponding to the image pixel having the highest code level as a reference.

In example embodiments, the prior information may include information on a probability distribution of each of a plurality of pixels becoming bad pixels after a certain period of time, or information on a code level of an image pixel having a high probability of occurrence of a bad pixel after a certain period of time.

Referring to FIG. 10, the image signal processor may detect a pixel belonging to a second group D2 different from the first group among a plurality of pixels as a second bad pixel using prior information. In example embodiments, the first bad pixel and the second bad pixel may be different from each other. The second bad pixel may not be the pixel with the highest defect probability or the highest code level of the image pixel among the candidate pixels C1 to Ci. In example embodiments, the pixel belonging to the second group D2 may be a pixel with a high probability of becoming a bad pixel over time.

Referring to FIG. 10, the third candidate pixel C3 may be a pixel distributed in a place where a certain period of time has passed among the plurality of pixels and where a certain period of time has passed. Alternatively, the code level of the image pixel corresponding to the third candidate pixel C3 may be included in a range of code levels of the image pixel with a high probability of becoming a bad pixel over time (compared to that of other code levels).

The image signal processor may detect a pixel with a high probability of becoming a bad pixel as a bad pixel using prior information among the plurality of pixels. An image signal processor according to example embodiments may detect bad pixels using such prior information and improve the performance of an imaging device.

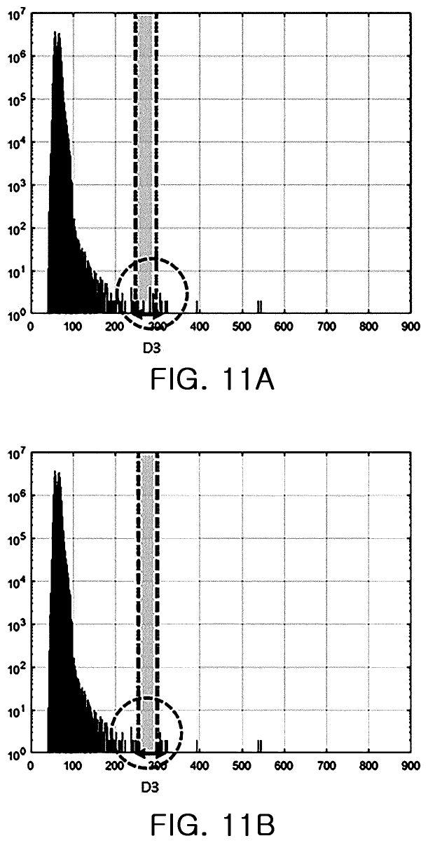

FIGS. 11A and 11B are graphs illustrating the distribution of a plurality of pixels according to example embodiments.

The X-axis of the graphs of FIGS. 11A and 11B may represent a code level, and the Y-axis may represent the number of pixels.

The graph of FIG. 11A is a graph illustrating the results of a dark image test performed after the image signal processor, according to example embodiments, detects a pixel belonging to a first group whose code level exceeds an outlier reference value among image pixels corresponding to a plurality of pixels as a first bad pixel and performs correction on the first bad pixel.

Referring to the graph of FIG. 11A, the first group may refer to pixels whose code level of the corresponding image pixel exceeds 300. The image signal processor may detect a pixel belonging to the first group whose code level of the corresponding image pixel exceeds 300 as the first bad pixel. In example embodiments, the image signal processor may correct a noise pixel corresponding to the first bad pixel. Referring to FIGS. 11A and 11B, most of the first bad pixels corresponding to image pixels having a code level of 300 or more may be corrected and may have little effect on image data.

The graph of FIG. 11B is a graph illustrating the results of an image signal processor according to example embodiments detecting pixels belonging to a second group, different from the first group, among a plurality of pixels as second bad pixels using prior information on code levels having a high probability of occurrence of bad pixels over a certain period of time, correcting noise pixels corresponding to the second bad pixels, and performing a dark image test.

In example embodiments, the prior information may include information that pixels corresponding to image pixels having a code level between 260 and 270 have a high probability of becoming bad pixels over time. The second group D3 may include pixels corresponding to image pixels having a code level between 260 and 270. The image signal processor may detect pixels belonging to the second group D3 corresponding to image pixels having a code level between 260 and 270 as second bad pixels. In example embodiments, the image signal processor may compensate for the noise pixel corresponding to the detected second bad pixel. Referring to the graph of FIG. 11B, the noise pixel corresponding to the second bad pixel in the pixels belonging to the second group D3 may be compensated so as not to affect the image data.

The image signal processor according to example embodiments may detect the bad pixel using prior information, and significantly reduce the influence of the bad pixel on the image data by compensating the noise pixel corresponding to the bad pixel, and may improve the performance of the imaging device.

As set forth above, according to example embodiments, an image signal processor includes prior information about a distribution of respective pixels having a high probability of becoming a bad pixel among a plurality of pixels, or prior information about pixels having a code level having a high probability of occurring as a bad pixel among the plurality of pixels, and may detect and correct pixels exceeding an outlier reference value and pixels falling within a range obtained using the prior information, as bad pixels. The image signal processor may improve performance of an imaging device by detecting bad pixels caused by a cause such as radiation using the prior information and correcting pixel values generated by the bad pixels.

While example embodiments have been illustrated and described above, it will be apparent to those skilled in the art that modifications and variations could be made without departing from the scope of the present inventive concepts as defined by the appended claims.

What is claimed is:

1. An imaging device comprising:
an image sensor including a plurality of pixels converting an optical signal into an electrical signal; and
an image signal processor (ISP),
wherein the image signal processor is configured to determine a defect probability of at least some of the plurality of pixels being a bad pixel, is configured to detect a pixel among the plurality of pixels as a first bad pixel belonging to a first group in which the defect probability exceeds an outlier reference value, and is configured to detect a pixel among the plurality of pixels as a second bad pixel belonging to a second group, different from the first group, using prior information on a probability distribution of the plurality of pixels becoming bad pixels after a certain period of time.

2. The imaging device of claim 1, wherein the image signal processor is configured to determine a sub-pixel group including some pixels from among the plurality of pixels, is configured to determine a target pixel and candidate pixels from among the some pixels, is configured to compare the candidate pixels with the target pixel respectively, and is configured to list the candidate pixels based on a defect probability of the candidate pixels.

3. The imaging device of claim 2, wherein the sub-pixel group has a size of 3×3, the target pixel is a pixel positioned at a center of the sub-pixel group, and the candidate pixels are remaining eight pixels excluding the target pixel.

4. The imaging device of claim 2, wherein the plurality of pixels each include one color filter among a first color filter, a second color filter, and a third color filter, and
the target pixel and the candidate pixels include at least one color filter among the first color filter, the second color filter, and the third color filter.

5. The imaging device of claim 2, wherein the first group includes a pixel having a highest defect probability among the candidate pixels.

6. The imaging device of claim 1, wherein the image signal processor is configured to determine a sub-pixel group including some pixels among the plurality of pixels, is configured to determine a target pixel and candidate pixels among the some pixels, is configured to compare the candidate pixels with the target pixel respectively, and is configured to list the candidate pixels based on a difference between a defect probability of the candidate pixels and a defect probability of the target pixel.

7. The imaging device of claim 1, wherein a plurality of image pixels corresponding to the plurality of pixels include a first noise pixel appearing due to the first bad pixel, and a second noise pixel appearing due to the second bad pixel, and
the image signal processor corrects the first noise pixel and the second noise pixel.

8. The imaging device of claim 7, wherein the image signal processor is configured to replace a pixel value of the first noise pixel with an average of pixel values of four other image pixels adjacent to top, bottom, left, and right of the first noise pixel, and is configured to replace a pixel value of the second noise pixel with an average of pixel values of four other image pixels adjacent to top, bottom, left, and right of the second noise pixel.

9. The imaging device of claim 1, wherein the image signal processor is configured to set the outlier reference value based on a pixel with a highest defect probability.

10. The imaging device of claim 1, wherein the second bad pixel is a dynamic bad pixel.

11. The imaging device of claim 10, wherein the second bad pixel is a hot pixel.

12. The imaging device of claim 1, wherein a pixel array including the plurality of pixels has a Bayer pattern.

13. An imaging device comprising:
an image sensor including a plurality of pixels converting an optical signal into an electrical signal; and
an image signal processor (ISP),
wherein the image signal processor is configured to determine a code level of at least some of the plurality of pixels, which is a digital value of a digital signal output by each pixel, is configured to detect a pixel among the plurality of pixels as a first bad pixel belonging to a first group in which the code level exceeds an outlier reference value, and is configured to detect a pixel among the plurality of pixels as a second bad pixel belonging to a second group, different from the first group, by using prior information about a code level at which a probability of occurrence of the bad pixel is higher than that of other code levels over a certain period of time.

14. The imaging device of claim 13, wherein the image signal processor is configured to determine a sub-pixel group including some pixels from among the plurality of pixels, is configured to determine a target pixel and candidate pixels among the some pixels, is configured to compare the candidate pixels with the target pixel respectively, and is configured to list the candidate pixels based on code levels corresponding to the candidate pixels.

15. The imaging device of claim 14, wherein the plurality of pixels each include one color filter among a first color filter, a second color filter, and a third color filter, and
the target pixel and the candidate pixels include a same color filter.

16. The imaging device of claim 14, wherein the plurality of pixels each include one color filter among a first color filter, a second color filter, and a third color filter, and
the target pixel and the candidate pixels include at least one color filter among the first color filter, the second color filter, and the third color filter.

17. The imaging device of claim 14, wherein the first group includes a pixel having a highest code level among the candidate pixels.

18. The imaging device of claim 13, wherein the image signal processor is configured to determine a sub-pixel group including some pixels among the plurality of pixels, is configured to determine a target pixel and candidate pixels among the some pixels, is configured to compare the candidate pixels with the target pixel respectively, and is configured to list the candidate pixels based on a difference between code levels corresponding to the candidate pixels and a code level corresponding to the target pixel.

19. The imaging device of claim 13, wherein a plurality of image pixels corresponding to the plurality of pixels include a first noise pixel appearing due to the first bad pixel, and a second noise pixel appearing due to the second bad pixel, and
the image signal processor is configured to replace a pixel value of the first noise pixel with an average of pixel values of four other image pixels adjacent to upper, lower, left, and right of the first noise pixel, and is configured to replace a pixel value of the second noise pixel with an average of pixel values of four other image pixels adjacent to upper, lower, left, and right of the second noise pixel.

20. An imaging device comprising:
an image sensor including a plurality of pixels converting an optical signal into an electrical signal; and
an image signal processor (ISP),
wherein the image signal processor is configured to detect a bad pixel among the plurality of pixels by using prior information about a probability distribution of the plurality of pixels respectively becoming a bad pixel after a certain period of time, and is configured to correct a pixel value of a noise pixel corresponding to the bad pixel by replacing the pixel value with an average of pixel values of four other image pixels adjacent to the noise pixel.
